(19) United States
(12) Patent Application Publication
(10) Pub. No.: US 2022/0149637 A1
(43) Pub. Date: May 12, 2022

(54) CHARGING MODULE WITH MOISTURE-PROOF PAD AND CLEANING SYSTEM HAVING THE SAME

(71) Applicant: Hobot Technology Inc., Chupei City (TW)

(72) Inventors: Chi-Mou CHAO, Zhubei City (TW); Hsuan-Yi LU, Chupei City (TW)

(21) Appl. No.: 17/402,130

(22) Filed: Aug. 13, 2021

(30) Foreign Application Priority Data
Nov. 9, 2020 (CN) 202011238224.8

(51) Int. Cl. H02J 7/00; A47L 11/40

(52) U.S. Cl. CPC H02J 7/0042; A47L 2201/022; A47L 2201/04; A47L 11/4011

(57) ABSTRACT

The present disclosure provides a charging module with a moisture-proof pad and a cleaning system. The charging module is used for charging a cleaning device. The charging module includes a moisture-proof pad, a charging means and at least an adhesive sheet. The moisture-proof pad is used for disposing the cleaning device thereon. The charging means is disposed on the moisture-proof pad for charging the cleaning device. The adhesive sheet is disposed on a lower surface of the moisture-proof pad for adhering the moisture-proof pad to a surface. The adhesive sheet is disposed on the lower surface of the moisture-proof pad. The manufacturing method of the present disclosure is simple with low cost, and can reduce the problem that the moisture-proof pad of the charging module cannot be smoothly attached to the floor.

### BACKGROUND OF THE INVENTION

### 1. Field of the Invention

The present disclosure relates to a charging module and a cleaning system, and more particularly to a charging module with a moisture-proof pad and a cleaning system having the same

### 2. Description of the Related Art

A self-propelled cleaning device with a wet mopping function is well known and is provided with a liquid storage tank. When the self-propelled cleaning device is charged, it will stand still, and the liquid in the liquid storage tank may leak to the floor, and thus cause the floor to be wet and damaged. CN208973678U discloses a moisture-proof pad for a cleaning device. As shown in FIG. 1A and FIG. 1B, the conventional moisture-proof pad 40 is provided with a sink portion 10, and when the self-propelled cleaning device is at the charging position, the sink portion 10 is located below the liquid storage tank of the self-propelled cleaning device. The sink portion 10 is designed such that the vertical distance between the upper surface of the sink portion 10 and the upper surface of the moisture-proof pad 40 is 0.6 mm to 0.8 mm. A mounting portion is disposed on the moisture-proof pad 40 for connecting with the charging device, and the mounting portion is a recessed portion 20 that is recessed horizontally inward from the edge of the moisture-proof pad 40. A plurality of anti-skid components 30 protruding downward and having a circular cross section are disposed on the bottom of the moisture-proof pad 40.

The conventional moisture-proof pad 40 is made of a hard material, is easily deformed, and has the periphery which is not easily attached to the floor. After being deformed, it is hard for the moisture-proof pad to restore, and thus there is a gap between the moisture-proof pad 40 and the floor. Therefore, the side bristles of the cleaning device are easy to insert into the gap, and the dust on the floor is also easy to accumulate in the gap. In addition, when manufacturing the conventional moisture-proof pad 40, it is necessary to attach an anti-skid means 30 to the lower surface of the moisture-proof pad 40, which consumes a lot of time and causes high manufacturing costs.

### BRIEF SUMMARY OF THE INVENTION

It is an object of the present disclosure to provide a charging module with a moisture-proof pad which is made by a simple manufacturing method with a low cost, and the charging module can reduce the problem that the moisture-proof pad cannot be smoothly attached to the floor.

It is another object of the present disclosure to provide a cleaning system having the above charging module.

In order to achieve the above objects, an embodiment of the present disclosure provides a charging module, which may be a charging module for a cleaning device and used for charging a cleaning device. The charging module includes a moisture-proof pad, a charging means and at least an adhesive sheet. The moisture-proof pad is configured for disposing the cleaning device thereon. The charging means is disposed on the moisture-proof pad for charging the cleaning device. The adhesive sheet is disposed on a lower surface of the moisture-proof pad for adhering the moisture-proof pad to a surface, and the adhesive sheet is disposed on the lower surface of the moisture-proof pad.

In an embodiment, the lower surface of the charging module includes a first side and a second side, and the adhesive sheet includes a first adhesive sheet and a second adhesive sheet. The first adhesive sheet is disposed on the first side of the lower surface of the moisture-proof pad for adhering the moisture-proof pad to a plate, and an outer surface of the first adhesive sheet is aligned with an outer surface of the first side. The second adhesive sheet is disposed on the second side of the lower surface of the moisture-proof pad for adhering the moisture-proof pad to the plate, and an outer surface of the second adhesive sheet is aligned with an outer surface of the second side.

In an embodiment, the moisture-proof pad is a sheet, and any part of the moisture-proof pad has a thickness between 0.2 mm and 5 mm. Preferably, the moisture-proof pad is made of a PVC material. In an embodiment, the adhesive sheet is adhered to a substrate and then cut to form the moisture-proof pad.

In an embodiment, the adhesive sheet is a sheet having a thickness between 0.1 mm and 1 mm. Preferably, the adhesive sheet is made of a PU material.

In an embodiment, the charging module further includes a release layer, which is adhered to a lower surface of the adhesive sheet.

In an embodiment, a position of the first adhesive sheet is on the opposite side of a position of the second adhesive sheet, and an extension direction of the first adhesive sheet is parallel to an extension direction of the second adhesive sheet.

In an embodiment, the lower surface of the moisture-proof pad includes a third side and a fourth side. The adhesive sheet includes a third adhesive sheet and a fourth adhesive sheet. The third adhesive sheet is disposed on the third side of the lower surface of the moisture-proof pad for adhering the moisture-proof pad to the plate, and an outer surface of the third adhesive sheet is aligned with an outer surface of the third side. The fourth adhesive sheet is disposed on the fourth side of the lower surface of the moisture-proof pad for adhering the moisture-proof pad to the plate, and an outer surface of the fourth adhesive sheet is aligned with an outer surface of the fourth side. Preferably, in an embodiment, a position of the third adhesive sheet is on the opposite side of a position of the fourth adhesive sheet, and an extension direction of the third adhesive sheet is parallel to an extension direction of the fourth adhesive sheet. The extension direction of the third adhesive sheet is perpendicular to the extension direction of the first adhesive sheet. Also, the third adhesive sheet and the fourth adhesive sheet are respectively disposed between the first adhesive sheet and the second adhesive sheet.

An embodiment of the present disclosure provides a cleaning system, which includes a cleaning device and the charging module in any one of the preceding embodiments. The charging module is used for charging the cleaning device.

As described above, according to an embodiment of the present invention, the problem that the moisture-proof pad of the charging module cannot be smoothly attached to the floor can be reduced. In an embodiment, it is preferable to provide a moisture-proof pad for a charging module with a simple manufacturing method and low cost.

### BRIEF DESCRIPTION OF THE DRAWINGS

The following drawings are only intended to schematically illustrate and explain the present disclosure, and do not limit the scope of the present disclosure.

FIG. 1A is a perspective view showing a conventional moisture-proof pad.

FIG. 1B is a top view of the conventional moisture-proof pad of FIG. 1A.

FIG. 2A is a perspective view showing a charging module according to an embodiment of the present disclosure.

FIG. 2B is a schematic view showing a cross-sectional view along the line A-A of the charging module in FIG. 2A.

FIG. 2C is a schematic view showing a cross-sectional view along the line A-A of the charging module in FIG. 2A when the release layer of the embodiment of FIG. 2A is removed and adhered to the floor.

FIG. 3A shows an exploded view of the charging module in FIG. 2A.

FIG. 3B shows an exploded view of the charging module in FIG. 2A.

FIG. 3C shows an exploded view of the charging module in FIG. 2A.

FIG. 4 is a perspective view showing a cleaning system according to an embodiment of the present disclosure.

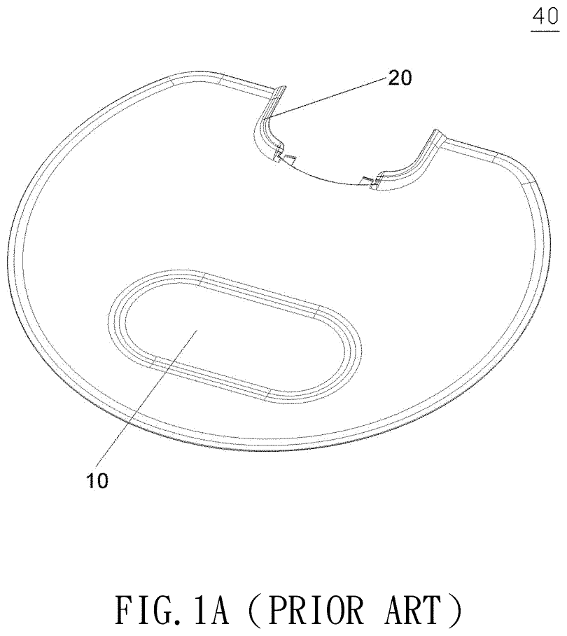

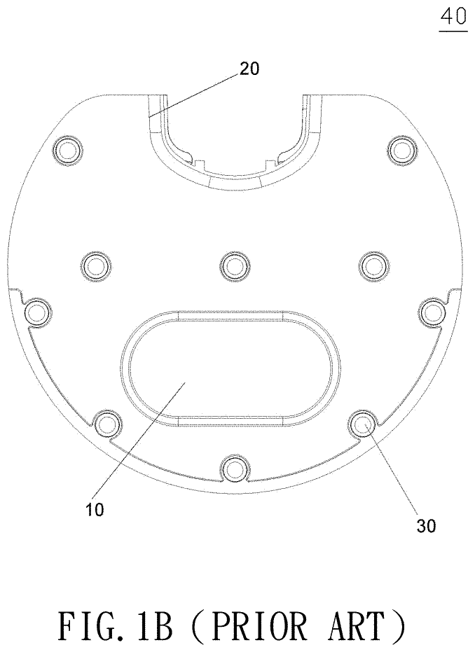

### DETAILED DESCRIPTION OF THE INVENTION

In order to have a clearer understanding of the technical solutions, objects and effects of the present disclosure, specific embodiments of the present disclosure will now be described with reference to the accompanying drawings.

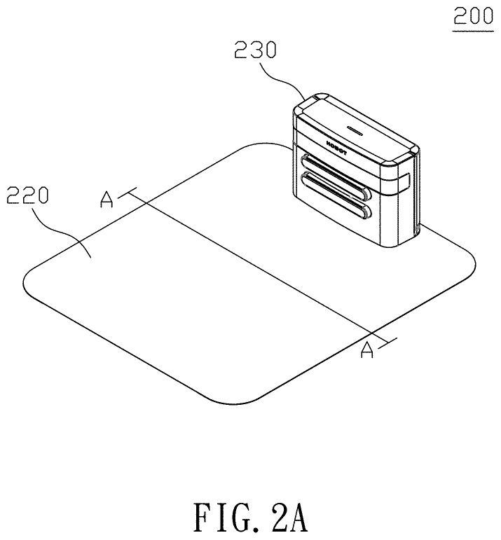

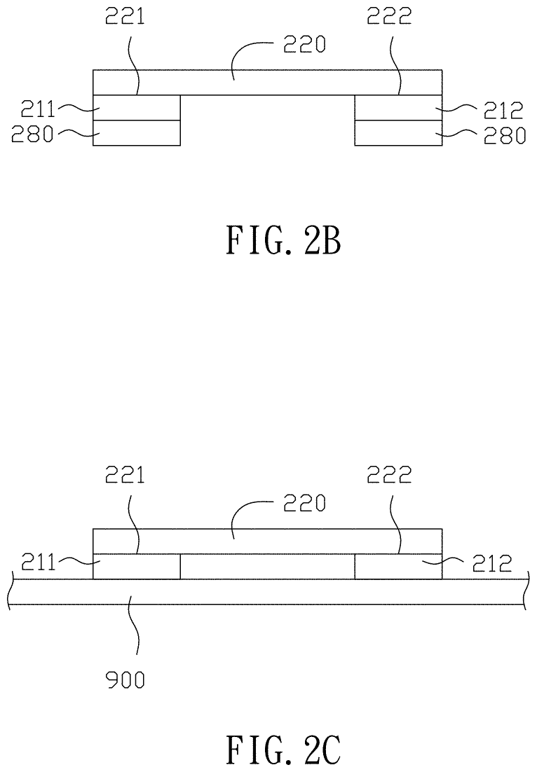

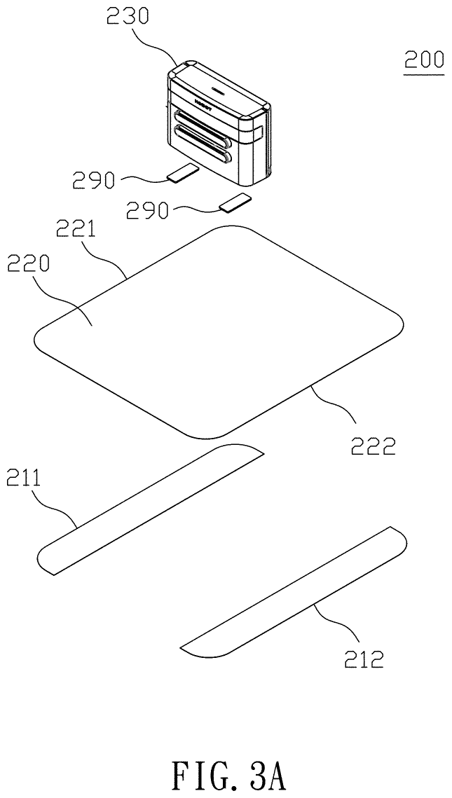

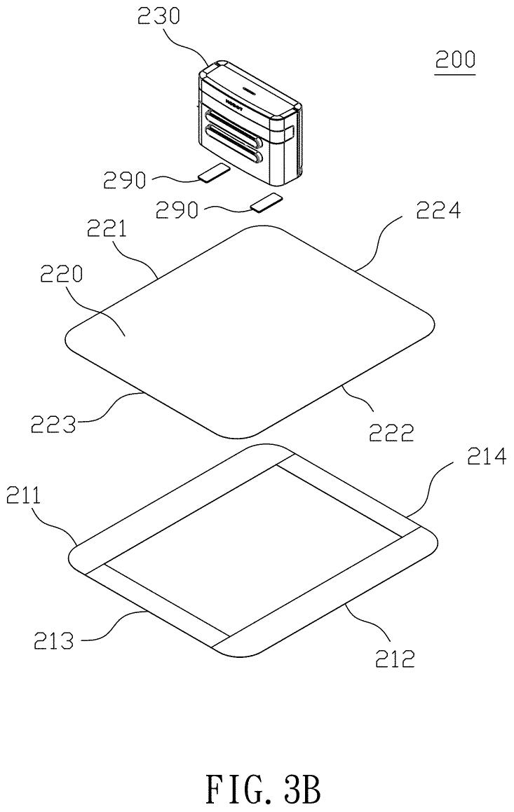

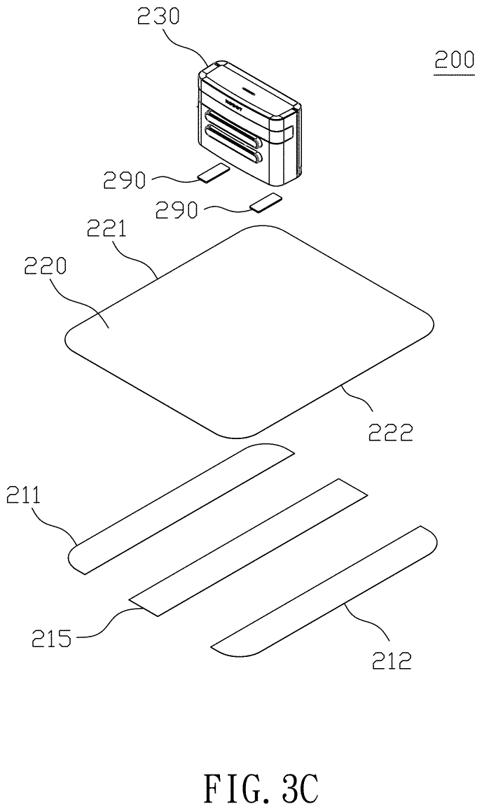

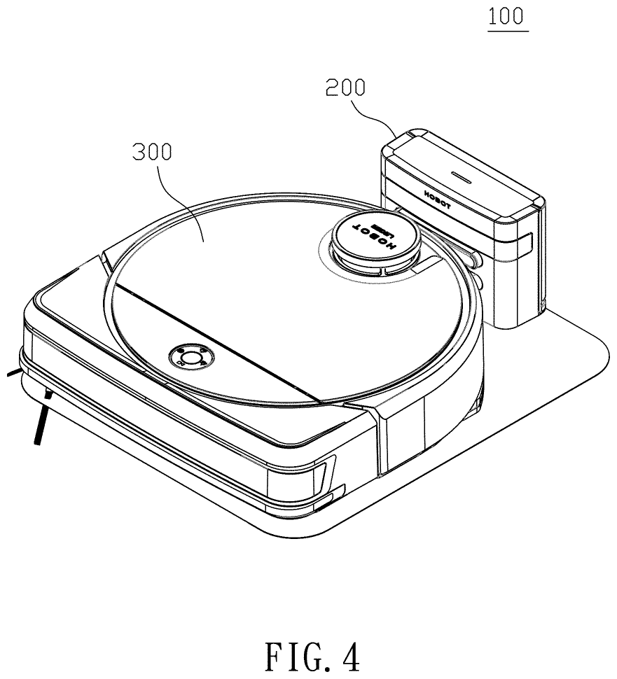

FIG. 2A is a perspective view showing a charging module according to an embodiment of the present disclosure. FIG. 3A shows an exploded view of the charging module in FIG. 2A. FIG. 4 is a perspective view showing a cleaning system according to an embodiment of the present disclosure. As shown in FIG. 2A, FIG. 3A and FIG. 4, a charging module 200 is provided for charging a cleaning device 300 according to an embodiment of the present disclosure. The charging module 200 includes a moisture-proof pad 220, a charging means 230 and at lease an adhesive sheet. The moisture-proof pad 220 is disposed on the floor, and the cleaning device 300 is disposed on the moisture-proof pad 220. The charging means 230 is disposed on the moisture-proof pad 220 for charging the cleaning device 300. The adhesive sheet is disposed at the lower surface of the moisture-proof pad 220 for adhering the moisture-proof pad 220 to a surface. The adhesive sheet is disposed at the lower surface of the moisture-proof pad 220. When the cleaning device 300 is to be charged, it can smoothly move to the moisture-proof pad 220 disposed on the floor, and the charging module 200 can charge the cleaning device 300.

In an embodiment, the charging module 200 further includes at least an adhesive layer 290. In FIG. 3A, there are two adhesive layers 290 adhered between the charging means 230 and the moisture-proof 220 to fix the charging means 230 on the moisture-proof pad 220. The material of the adhesive layer 290 is not limited in the present disclosure as long as the charging device 230 can be fixed. From the perspective that the charging means 230 can be removed and repeatedly adhered to the charging device 230, the material of the adhesive layer 290 may preferably be polyurethane or silicone.

As shown in FIG. 3A, the adhesive sheet includes a first adhesive sheet 211 and a second adhesive sheet 212. The lower surface of the moisture-proof pad 220 includes a first side 221 and a second side 222. The first adhesive sheet 211 is disposed on the first side 221 of the moisture-proof pad 220 for adhering the moisture-proof pad 220 to the surface of the floor, and an outer side surface of the first adhesive sheet 211 is substantially aligned with an outer surface of the first side 221. The term “substantially aligned” means that it is aligned to an extent within the range of process tolerance. In this way, the gap between the first side 221 of the moisture-proof pad 220 and the floor can be reduced, and preferably the gap substantially does not exist. The second adhesive sheet 212 is disposed on the second side 222 of the lower surface of the moisture-proof pad 220 for adhering the moisture-proof pad 220 to the surface of the floor, and an outer side surface of the second adhesive sheet 212 is substantially aligned with an outer surface of the second side 222. In this way, the gap between the second side 222 of the moisture-proof pad 220 and the floor can be reduced, and preferably the gap substantially does not exist. In this embodiment, preferably, the position of the first side 221 is on the opposite side of the position of the second side 222. The position of the first adhesive sheet 211 is on the opposite side of the position of the second adhesive sheet 212, the first adhesive sheet 211 is a long strip, and an extension direction of the first adhesive sheet 211 is parallel to an extension direction of the second adhesive sheet 212.

The material of the adhesive sheet is not limited in the present disclosure as long as the moisture-proof pad 220 can be adhered to the surface of the floor. From the perspective of reusability, it is preferred to use a material which can restore at least a part of its viscosity after be washed with water. More preferably, the material of the adhesive sheet includes polyurethane (PU) or silicone. More specifically, polyurethane has the better adhesive recovery after being washed with water, and it can be recycled and reused. As the raw material of the adhesive, polyurethane can be designed to form various molecular structures according to various requirements, and can also be copolymerized and modified with other types of resins, so as to meet the subsequent processing of various materials with different characteristics. Preferably, the material of the adhesive sheet is a polyurethane elastomer (PU elastomer) made of a material containing at least polyurethane. In addition, polyurethane (PU) can be a polymer formed by the reaction of polyol (polyol), isocyanate (isocyanate) and a bond extender (chain extender). The polyols include two types: ethers (polyether) and esters (polyester). The PU synthesized by the ethers (polyether) has water resistance, and the PU synthesized by the esters (polyester) has oil resistance. The application range of PU can be used separately with reference to the comparison of these two characteristics. Examples of the bond extenders include commercially available Lonzacure DETDA (diethyltoluenediamine), Lonzacure M-CDEA, Lonzacure M-DEA, Lonzacure M-DIPA, Lonzacure M-MIPA, and the like.

Preferably, silicone is made of an adhesive material. In an embodiment, the composition of silicone includes raw rubber, silica, silicone oil or silicone oil mixture, a bridging agent and the like. The raw rubber can be natural rubber or synthetic rubber. Commonly used natural rubbers are smoked sheet rubber and standard rubber. Commonly used synthetic rubbers are styrene butadiene rubber, butadiene rubber, and butyl rubber. The raw rubber is mixed with silica to strengthen the structure, the silicone oil mixture is used to produce the required adhesion, the hardness of the main body is changed by the ratio of the components, and the bridging agent is used to promote the combination of the components. The silicone oil mixture includes silicone oil, dimethyl silicone oil, and phenyl silicone oil.

The adhesive sheet is in the form of a sheet. When the adhesive sheet is too thick, the gap will be too large, and the side bristles of the cleaning device 300 will brush the dust into the gap. Further, when the thickness of the pad adhesive sheet is greater than 1mm, the bristles will easily be inserted into the gap and be stuck in the gap, which will affect the moving of the cleaning device. When the adhesive sheet is too thin, it is not easy to fabricate the adhesive sheet. That is, when the adhesive sheet is too thin, it is not easy to use a roller to control the manufacturing process, so when the pad adhesive sheet is too thin, its mass production is not efficient. In addition, when the adhesive sheet is too thin, it is not easy to attach the adhesive sheet to the moisture-proof pad 220. More specifically, it is difficult to control the attachment of the adhesive sheet and requires more time for the attachment of the adhesive sheet. Therefore, preferably, any part of the adhesive sheet has a thickness between 0.1 mm and 1 mm, preferably between 0.2 mm and 0.5 mm. In this embodiment, the thickness of the adhesive sheet is 0.3 mm. When the thicknesses of the first adhesive sheet 211 and the second adhesive sheet 212 are too thick, the gap between the third or fourth side of the moisture-proof pad 220 of the embodiment in FIG. 3A and the floor is too large, and the moisture-proof pad 220 also protrudes significantly from the floor. When the thicknesses of the first adhesive sheet 211 and the second adhesive sheet 212 are too thin, the first adhesive sheet 211 and the second adhesive sheet 212 cannot provide effective elasticity, the mass production is not efficient, and it takes longer time for the attaching process. In an embodiment, any part of the adhesive sheet can be 0.1 mm, 0.2 mm, 0.3 mm, 0.4 mm, 0.5 mm, 1 mm or between any two of the aforementioned numbers, preferably between 0.2 mm and 0.5 mm.

The material of the moisture-proof pad is not limited in the present disclosure, as long as it can reduce the warpage and increase the effect that the moisture-proof pad 220 is smoothly adhered to the surface of the floor. The moisture-proof pad can be a plastic sheet. The moisture-proof pad is made of plastic, such as polycarbonate (PC), polyethylene terephthalate (PET), polypropylene (PP), polyethylene (PE) or polyvinyl chloride (PVC). From the perspective of the adhesion of the moisture-proof pad 220 to the floor, since the adhesion of polyvinyl chloride (PVC) is better than that of plastics such as polypropylene (PP) and polycarbonate (PC), the material of the moisture-proof pad 220 preferably is polyvinyl chloride (PVC).

The method for forming the moisture-proof pad is not limited in the present disclosure, as long as it can increase the effect that the moisture-proof pad 220 smoothly adhered to the surface of the floor. In order to simplify the manufacturing and lower the cost, it is preferable that the moisture-proof pad 220 is cut from a whole substrate (for example, a plastic substrate) to form a cut piece. In an embodiment, preferably, the moisture-proof pad 220 can be made by adhering an adhesive sheet to a substrate (for example, a plastic substrate), and then cutting the substrate (for example, a plastic substrate) to which the adhesive sheet is attached, so that the outer side surface of the adhesive sheet is aligned with one side of the moisture-proof pad 220.

When the thickness of the moisture-proof pad 220 is too thin, the moisture-proof pad 220 cannot fit on the floor flatly. When the thickness of the moisture-proof pad 220 is too thick, the cleaning cloth on the bottom surface of the cleaning device 300 is likely to be stuck, resulting in that the cleaning cloth is skew or fall off, or the moisture-proof pad 220 may easily slide on the floor. In addition, when the thickness of the moisture-proof pad 220 is less than 0.2 mm, the moisture-proof pad 220 will form creases when the moisture-proof pad 220 is torn from the floor, and the moisture-proof pad 220 is no longer flat and has creases. However, when the thickness of the moisture-proof pad 220 is greater than 0.2 mm, the creases can be significantly reduced. Preferably, the moisture-proof pad 220 is sheet-shaped (0.35T), and the thickness of any part of the moisture-proof pad 220 is between 0.2 mm and 5 mm, preferably between 0.2 mm and 1 mm, and more preferably between 0.2 mm and 0.6 mm. In this embodiment, the thickness of the moisture-proof pad 220 is 0.25 mm. In an embodiment, the thickness of the moisture-proof pad 220 can be 0.2 mm, 0.25 mm, 0.3 mm, 0.4 mm, 0.5 mm, 0.6 mm, 0.7 mm, 1 mm, 3 mm, 5 mm, or in a range between any two of the foregoing numbers. PVC has good flatness and wrinkle resistance.

In addition, the cleaning device 300 has a reciprocating brush plate, the cleaning cloth is attached to the reciprocating brush plate, and the thickness of the moisture-proof pad 220 is greater than 5 mm, which results in that the reciprocating movement of the reciprocating brush plate may cause the cleaning cloth to skew or fall off, or the moisture-proof pad 220 slide on the floor. Thus, in this cleaning device, the thickness of the moisture-proof pad is preferably less than or equal to 5 mm. Further, when the thickness of the moisture-proof pad 220 is greater, the more materials are needed to form the moisture-proof pad 220, and the manufacturing cost will be higher. Therefore, preferably, the thickness of the moisture-proof pad 220 is less than or equal to 1 mm, and more preferably less than or equal to 0.6 mm.

FIG. 2B is a schematic view showing a cross-sectional view along the line A-A of the charging module in FIG. 2A. As shown in FIG. 2B, in an embodiment, the charging module 200 further includes a release layer 280. The release layer 280 is adhered to the lower surface of the adhesive sheet. The release layer 280 can include at least a release paper. In this embodiment, the release layer 280 includes multiple release papers. Before the moisture-proof pad 220 is used, the release papers of the release layer 280 are respectively adhered to the lower surfaces of the first adhesive sheet 211 and the second adhesive sheet 212. By using the adhesiveness of the pad adhesive sheet, the first adhesive sheet 211 and the second adhesive sheet 212 can be sandwiched between the release paper of the release layer 280 and the moisture-proof pad 220. The release paper of the release layer 280 is an anti-sticking paper that prevents sticking and can protect the adhesiveness of the second adhesive sheet 212. In an embodiment, the release paper of the release layer 280 is made of paper coated with a release material.

FIG. 2C is a schematic view showing a cross-sectional view along the line A-A of the charging module in FIG. 2A when the release layer of the embodiment of FIG. 2A is removed and adhered to the floor. As shown in FIG. 2C, in an embodiment, when using the moisture-proof pad 220, the release paper is removed, and then the moisture-proof pad 220 is adhered to the surface 900 of the floor. When it is found that the moisture-proof pad 220 is dirty, or the gap between the moisture-proof pad 220 and the floor is dirty, the moisture-proof pad 220 can be torn from the surface 900 of the floor. At this time, the adhesion between the first adhesive sheet 211 and the moisture-proof pad 220 and the adhesion between the second adhesive sheet 212 and the moisture-proof pad 220 are strong, and thus the first adhesive sheet 211 and the second adhesive sheet 212 are still adhered to the moisture-proof pad 220. Finally, after cleaning the moisture-proof pad 220, the first adhesive sheet 211 and the second adhesive sheet 212, the moisture-proof pad 220 can be re-adhered to the floor.

FIG. 3B shows an exploded view of the charging module according to an embodiment of the present disclosure. The embodiment of FIG. 3B is similar to the embodiment of FIG. 3A, so the similar elements use the similar symbols, and related descriptions are omitted. As shown in FIG. 3B, the adhesive sheet further includes a third adhesive sheet 213 and a fourth adhesive sheet 214. Further, the lower surface of the moisture-proof pad 220 includes a third side 223 and a fourth side 224. The third adhesive sheet 213 is disposed on the third side 223 of the lower surface of the moisture-proof pad 220 for adhering the moisture-proof pad 220 to the plate, and an outer side surface of the third adhesive sheet 213 is substantially aligned with the outer surface of the third side 223. The fourth adhesive sheet 214 is disposed on the fourth side 224 of the lower surface of the moisture-proof pad 220 for adhering the moisture-proof pad 220 to the plate, and an outer side surface of the fourth adhesive sheet 214 is substantially aligned with the outer surface of the fourth side 224. A position of the third adhesive sheet 213 is on the opposite side of a position of the fourth adhesive sheet 214, the third adhesive sheet 213 is a long strip, and an extension direction of the third adhesive sheet 213 is parallel to an extension direction of the fourth adhesive sheet 214. The extension direction of the third adhesive sheet 213 is perpendicular to the extension direction of the first adhesive sheet 211, and the third adhesive sheet 213 and the fourth adhesive sheet 214 are respectively disposed between the first adhesive sheet 211 and the second adhesive sheet 212.

FIG. 3C shows an exploded view of the charging module according to an embodiment of the present disclosure. The embodiment of FIG. 3C is similar to the embodiment of FIG. 3A, so the similar elements use the similar symbols, and related descriptions are omitted. As shown in FIG. 3C, the adhesive sheet further includes a fifth adhesive sheet 215. The fifth adhesive sheet 215 is a long strip, and the extension direction of the fifth adhesive sheet 215 is parallel to the extension direction of the first adhesive sheet 211 and the second adhesive sheet 212. Further, the fifth adhesive sheet 215 is disposed between the first adhesive sheet 211 and the second adhesive sheet 212, and preferably in the middle portion between the first adhesive sheet 211 and the second adhesive sheet 212. Preferably, the middle part (middle line) between the first adhesive sheet 211 and the second adhesive sheet 212 is located in the fifth adhesive sheet 215.

As shown in FIG. 3A, FIG. 3B and FIG. 3C, preferably, the adhesive sheet is not adhered to the entire lower surface of the moisture-proof pad 220, that is, at least one adhesive sheet is only adhered to a part of the lower surface instead of the entire lower surface. In this way, the moisture-proof pad 220 can be easily torn from the floor, and can be used repeatedly. Preferably, the area of the adhesive sheet adhered to the lower surface is less than 50% of the area of the lower surface and more than 10% of the area of the lower surface.

FIG. 4 is a perspective view showing a cleaning system according to an embodiment of the present disclosure. According to an embodiment of the present disclosure, a cleaning system 100 is provided. The cleaning system 100 includes the cleaning device 300 and the charging module 200. The charging module 200 is used for charging the cleaning device 300.

The foregoing descriptions merely provide specific embodiments of the present disclosure, and are not intended to limit the scope of the present disclosure. Any equivalent changes and modifications made by a person skilled in the art without departing from the concept and principle of the present disclosure shall fall within the scope of the present disclosure. Moreover, it should be noted that the various components of the present disclosure are not limited to the above-mentioned applications. Each technical feature described in the specification of the present disclosure can be selected individually or used in combination according to actual needs. Therefore, other combinations and specific applications related to the present disclosure are also in the scope of claims of the present disclosure.

What is claimed is:

1. A charging module for a cleaning device, comprising:
a moisture-proof pad, configured for disposing the cleaning device thereon;
a charging means, connected to the moisture-proof pad for charging the cleaning device; and
at least an adhesive sheet, disposed on a lower surface of the moisture-proof pad for adhering the moisture-proof pad to a surface.

2. The charging module according to claim 1, wherein the moisture-proof pad is a first sheet having a thickness between 0.2 mm and 5 mm.

3. The charging module according to claim 1, wherein the adhesive sheet is a sheet having a thickness between 0.1 mm and 1 mm.

4. The charging module according to claim 2, wherein the adhesive sheet is a second sheet having a thickness between 0.1 mm and 1 mm.

5. The charging module according to claim 1, wherein the lower surface includes a first side and a second side, and
the adhesive sheet includes:
a first adhesive sheet, disposed on the first side of the lower surface of the moisture-proof pad for adhering the moisture-proof pad to a plate, wherein an outer side surface of the first adhesive sheet is aligned with an outer surface of the first side of the lower surface; and
a second adhesive sheet, disposed on the second side of the lower surface of the moisture-proof pad for adhering the moisture-proof pad to the plate, wherein an outer side surface of the second adhesive sheet is aligned with an outer surface of the second side of the lower surface.

6. The charging module according to claim 1, wherein the moisture-proof pad is produced in the manner in which the adhesive sheet is adhered to a substrate and then cut to form the moisture-proof pad.

7. The charging module according to claim 1, wherein an area of the adhesive sheet adhered to the lower surface is no more than 50% of an area of the lower surface and no less than 10% of the area of the lower surface.

8. The charging module according to claim 1, wherein the adhesive sheet is made of a PU material or a silicone material.

9. The charging module according to claim 1, wherein the moisture-proof pad is made of plastic.

10. The charging module according to claim 9, wherein moisture-proof pad is made of a PVC material.

11. The charging module according to claim 1, wherein the charging module further includes a release layer, which is adhered to a lower surface of the adhesive sheet.

12. The charging module according to claim 5, wherein a position of the first adhesive sheet is on the opposite side of a position of the second adhesive sheet, and an extension direction of the first adhesive sheet is parallel to an extension direction of the second adhesive sheet.

13. The charging module according to claim 12, wherein
the lower surface of the moisture-proof pad includes: a third side and a fourth side, and
the adhesive sheet includes:
a third adhesive sheet, disposed on the third side of the lower surface of the moisture-proof pad for adhering the moisture-proof pad to the plate, wherein an outer side surface of the third adhesive sheet is aligned with an outer surface of the third side of the lower surface; and
a fourth adhesive sheet, disposed on the fourth side of the lower surface of the moisture-proof pad for adhering the moisture-proof pad to the plate, wherein an outer side surface of the fourth adhesive sheet is aligned with an outer surface of the fourth side of the lower surface,
a position of the third adhesive sheet is on the opposite side of a position of the fourth adhesive sheet, and an extension direction of the third adhesive sheet is parallel to an extension direction of the fourth adhesive sheet,
the extension direction of the third adhesive sheet is perpendicular to the extension direction of the first adhesive sheet, and
the third adhesive sheet and the fourth adhesive sheet are respectively disposed between the first adhesive sheet and the second adhesive sheet.

14. A cleaning system, comprising:
a cleaning device, and
the charging module comprising:
a moisture-proof pad, configured for disposing the cleaning device thereon;
a charging means, connected to the moisture-proof pad for charging the cleaning device; and
at least an adhesive sheet, disposed on a lower surface of the moisture-proof pad for adhering the moisture-proof pad to a surface.

15. The cleaning system according to claim 14, wherein the moisture-proof pad is a first sheet having a thickness between 0.2 mm and 5 mm.

16. The cleaning system according to claim 14, wherein the adhesive sheet is a sheet having a thickness between 0.1 mm and 1 mm.

17. The cleaning system according to claim 15, wherein the adhesive sheet is a second sheet having a thickness between 0.1 mm and 1 mm.

18. The cleaning system according to claim 14, wherein the lower surface of the moisture-proof pad includes a first side and a second side, and
the adhesive sheet includes:
a first adhesive sheet, disposed on the first side of the lower surface of the moisture-proof pad for adhering the moisture-proof pad to a plate, wherein an outer side surface of the first adhesive sheet is aligned with an outer surface of the first side of the lower surface; and
a second adhesive sheet, disposed on the second side of the lower surface of the moisture-proof pad for adhering the moisture-proof pad to the plate, wherein an outer side surface of the second adhesive sheet is aligned with an outer surface of the second side of the lower surface.

19. The cleaning system according to claim 14, wherein the moisture-proof pad is produced in the manner in which the adhesive sheet is adhered to a substrate and then cut to form the moisture-proof pad.

20. The cleaning system according to claim 14, wherein an area of the adhesive sheet adhered to the lower surface is no more than 50% of an area of the lower surface and no less than 10% of the area of the lower surface.
